(19) United States
(12) Patent Application Publication
(10) Pub. No.: US 2020/0412945 A1
(43) Pub. Date: Dec. 31, 2020

(54) IMAGE PROCESSING APPARATUS, IMAGE CAPTURING APPARATUS, MOBILE BODY, IMAGE PROCESSING METHOD, AND PROGRAM

(71) Applicant: SZ DJI TECHNOLOGY CO., LTD., Shenzhen (CN)

(72) Inventor: Ming SHAO, Shenzhen (CN)

(21) Appl. No.: 17/015,842

(22) Filed: Sep. 9, 2020

Related U.S. Application Data
(63) Continuation of application No. PCT/CN2018/120894, filed on Dec. 13, 2018.

(30) Foreign Application Priority Data
Mar. 14, 2018 (JP) 2018-046806

(51) Int. Cl. H04N 5/232; G06T 7/11; G06T 3/40; G06T 3/00; G06T 7/20; H04N 5/265; G06T 3/20; G06T 3/60; H04N 5/262; G06T 7/33

(52) U.S. Cl. CPC H04N 5/23232; G06T 7/11; G06T 3/4038; G06T 3/0068; G06T 7/20; G06T 2207/20212; H04N 5/265; G06T 3/20; G06T 3/60; H04N 5/2628; G06T 7/337; G06T 3/4053

(57) ABSTRACT

An image processing apparatus includes a memory storing a program and a processor. The processor is configured to: specify at least one partial area of a dynamic image; extract at least one partial image corresponding to the at least one partial area from each of a plurality of first images that constitutes the dynamic image; and combine the at least one partial image, for each of the plurality of first images, to generate a plurality of second images. The plurality of second images have image sizes smaller than that of the first image.

### CROSS-REFERENCE TO RELATED APPLICATIONS

This application is a continuation of International Application No. PCT/CN2018/120894, filed on Dec. 13, 2018, which claims priority to Japanese Application No. 2018-046806, filed Mar. 14, 2018, the entire contents of both of which are incorporated herein by reference.

### TECHNICAL FIELD

The disclosure relates to an image processing apparatus, an image capturing apparatus, a mobile body, an image processing method, and a program.

### BACKGROUND

Except for the pixels associated with a region of local motion in each image frame, an imaging system can replace pixels in each image frame with corresponding pixels from an anchor frame to generate a dynamic picture.

### SUMMARY

According to one aspect of the present disclosure, there is provided an image processing apparatus. The image processing apparatus includes a memory storing a program and a processor. The processor is configured to executed the program to: specify at least one partial area of a dynamic image; extract at least one partial image corresponding to the at least one partial area from each of a plurality of first images that constitutes the dynamic image; and combine the at least one partial image, for each of the plurality of first images, to generate a plurality of second images. The plurality of second images have image sizes smaller than that of the first image.

According to another aspect of the present disclosure, there is provided an image capturing apparatus. The image capturing apparatus includes an image processing apparatus. The image processing apparatus includes a memory storing a program and a processor. The processor is configured to execute the program to: specify at least one partial area of a dynamic image; extract at least one partial image corresponding to the at least one partial area from each of a plurality of first images that constitutes the dynamic image; and combine the at least one partial image, for each of the plurality of first images, to generate a plurality of second images. The plurality of second images have image sizes smaller than that of the first image.

According to further aspect of the present disclosure, there is provided a mobile body having an image capturing apparatus. The image capturing apparatus includes an image processing apparatus. The image processing apparatus includes a memory storing a program and a processor. The processor is configured to: specify at least one partial area of a dynamic image; extract at least one partial image corresponding to the at least one partial area from each of a plurality of first images that constitutes the dynamic image; and combine the at least one partial image, for each of the plurality of first images, to generate a plurality of second images. The plurality of second images have image sizes smaller than that of the first image.

### BRIEF DESCRIPTION OF THE DRAWINGS

FIG. 1 is a schematic diagram of functional blocks of an image processing apparatus according to some embodiments of the present disclosure;

FIG. 2 illustrates an alignment of a first image that constitutes a dynamic image according to some embodiments of the present disclosure;

FIG. 3 illustrates the alignment of the first image that constitutes the dynamic image according to some embodiments of the present disclosure;

FIG. 4 illustrates a partial area according to an embodiment of the present disclosure;

FIG. 5 illustrates a second image that is composed of the partial image according to some embodiments of the present disclosure;

FIG. 6 illustrates a process of embedding the partial image in a reference image according to some embodiments of the present disclosure;

FIG. 7 is a flowchart illustrating processing of a plurality of first images that constitute the dynamic image according to some embodiments of the present disclosure;

FIG. 8 is a flowchart illustrating processing of reproducing a video of the dynamic image according to some embodiments of the present disclosure;

FIG. 9 is a schematic diagram of appearance of an unmanned aerial vehicle (UAV) and a remote control device according to some embodiments of the present disclosure;

FIG. 10 is a schematic diagram of functional blocks of the UAV according to some embodiments of the present disclosure; and

FIG. 11 is a schematic diagram of a hardware configuration according to some embodiments of the present disclosure.

### REFERENCE NUMERALS

10—UAV; 20—UAV body; 30—UAV control unit; 32—memory; 36—communication interface; 40—propulsion unit; 41—GPS receiver; 42—inertial measurement device; 43—magnetic compass; 44—barometric altimeter; 45—temperature sensor; 46—humidity sensor; 50—universal joint; 60—image capturing apparatus; 100—image capturing apparatus; 102—image capturing unit; 110—imaging control unit; 120—image sensor; 130—memory; 200—lens unit; 210—lenses; 212—lens driver; 214—position sensor; 220—lens control sensor; 222—memory; 300—remote control device; 500—image processing apparatus; 510—processing unit; 511—acquisition unit; 512—selection unit; 513—alignment unit; 514—designation unit; 515—extraction unit; 516—generation unit; 517—compression unit; 518—synthesis unit; 519—display control unit; 520—storage unit; 530—display unit; 540—communication unit; 1200—computer; 1210—host controller; 1212—CPU; 1214—RAM; 1220—input/output controller; 1222—communication interface; and 1230—ROM.

### DETAILED DESCRIPTION OF THE EMBODIMENTS

Below the present disclosure will be described by embodiments of the disclosure, but the following embodiments do not limit the disclosure related to the claims. In addition, all combinations of the features described in the embodiments are not necessarily required for the solution in the disclosure. It is apparent to those skilled in the art that various variations or improvements can be made to the following embodiments. It is apparent from the claims that such variations or improvements shall be included in the technical scope of the present disclosure.

Various embodiments of the present disclosure may be described with reference to the flowcharts and block diagrams. The blocks may represent: (1) the stage of the process of performing the operation; or (2) the “part” of the apparatus having the function of performing the operation. Certain stages and “parts” can be implemented by programmable circuits and/or processors. The dedicated circuits may include digital and/or analog hardware circuits. It may include integrated circuits (ICs) and/or discrete circuits. The programmable circuit may include a reconfigurable hardware circuit. The reconfigurable hardware circuit can include logical AND, logical OR, logical Exclusive OR (EOR), logical NAND, logical NOR, and other logical operations, and memory components such as flip-flops, registers, field-programmable gate array (FPGA), and programmable logic array (PLA).

The computer-readable medium may include any tangible device that can store instructions executed by a suitable device. As a result, the computer-readable medium having instructions stored thereon has a product that includes instructions that can be executed to create a means for performing the operations specified by the flowchart or block diagram. Examples of the computer-readable media may include electronic storage media, magnetic storage media, optical storage media, electromagnetic storage media, semiconductor storage media, etc. More specific examples of the computer-readable media may include floppy disk, hard disk, random-access memory (RAM), read-only memory (ROM), erasable programmable read-only memory (EPROM, or flash memory), electrically erasable programmable read-only memory (EEPROM), static random-access memory (SRAM), compact disk read-only memory (CD-ROM), digital versatile disk (DVD), Blu-ray disk (release to manufacturing (RTM)), memory stick, IC cards, etc.

Computer-readable instructions may include any one of source code or object code described by any combination of one or more programming languages. The source code or object code includes traditional procedural programming languages. The traditional programming languages can be assembly instructions, instruction set architecture (ISA) instructions, machine instructions, machine-related instructions, microcode, firmware instructions, status setting data, or object-oriented programming languages or C programming languages such as Smalltalk, JAVA, C++, etc. The computer-readable instructions may be provided locally or via a wide area network (WAN) such as a local area network (LAN), the Internet, or the like, to a processor or programmable circuit of a general-purpose computer, a dedicated computer, or other programmable data processing device. A processor or programmable circuit can execute computer-readable instructions to create means for performing the operations specified by the flowchart or block diagram. Examples of the processor include a computer processor, a processing unit, a microprocessor, a digital signal processor, a controller, a microcontroller, and so on.

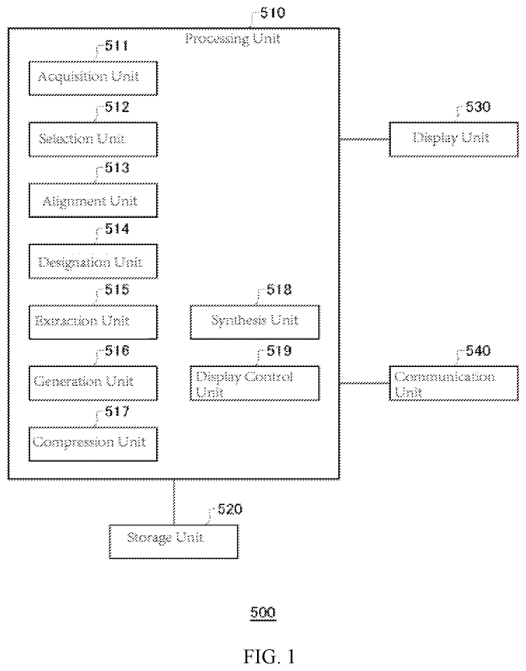

FIG. 1 is a schematic diagram illustrating functional blocks of the image processing apparatus 500 according to an embodiment of the present disclosure. The image processing apparatus 500 includes a processing unit 510, a storage unit 520, a display unit 530, and a communication unit 540. The image processing apparatus 500 may be, for example, a communication terminal. The communication terminal may be, for example, a personal computer, a portable terminal, or the like. The portable terminal may be a mobile phone, a smart phone, a personal digital assistant (PDA), a tablet computer, a notebook computer or a laptop computer, a wearable computer, or the like. The storage unit 520 may be a computer-readable storage medium, and may include at least one of the flash memories such as SRAM, DRAM, EPROM, EEPROM, and USB flash drive. The storage unit 520 may be disposed inside the image processing apparatus 500. The storage unit 520 may be detachable from the image processing apparatus 500.

The dynamic images captured by the image processing apparatus 500 may generate a video of the dynamic images. A motion picture is a video in which a part of a static image moves like a dynamic picture. The processing unit 510 includes an acquisition unit 511, a selection unit 512, an alignment unit 513, a designation unit 514, an extraction unit 515, a generation unit 516, a compression unit 517, a synthesis unit 518, and a display control unit 519.

The acquisition unit 511 acquires a dynamic image. The image processing apparatus 500 may include an image capturing unit. The acquisition unit 511 can acquire the dynamic image captured by the image capturing unit of the image processing apparatus 500. The acquisition unit 511 can acquire the dynamic image from an image capturing device connected to the image processing apparatus 500 via a wired or wireless network. The acquisition unit 511 can acquire dynamic images from other devices of a server connected via a wired or wireless network. The acquisition section 511 can acquire the dynamic image stored in the storage unit 520. The dynamic image may be a dynamic image obtained by image capturing in a predetermined image capturing range with an image capturing device in a predetermined image capturing direction, or under certain image capturing conditions such as a constant viewing angle.

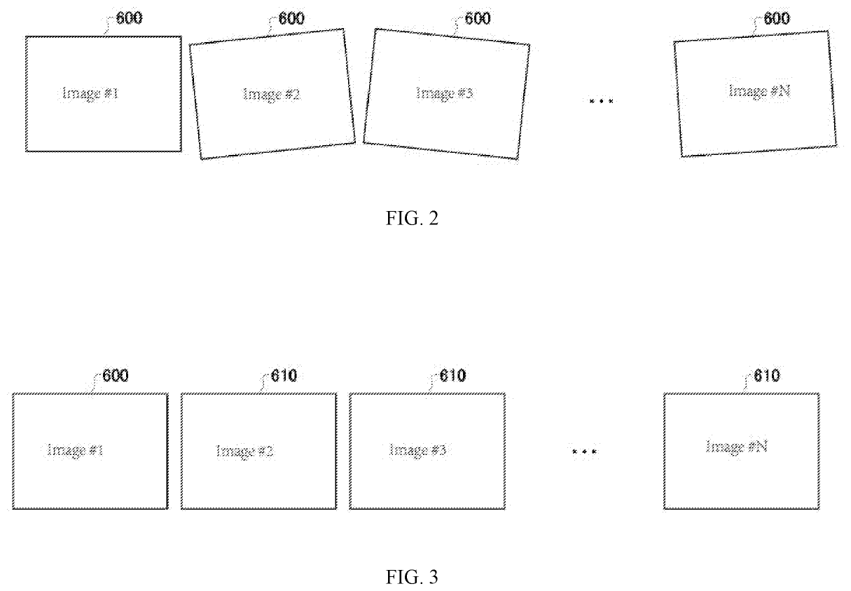

The selection unit 512 selects a reference image from a plurality of first images that constitute the dynamic image according to the predetermined conditions. The plurality of the first images may be static images that are continuous in time. For example, the selection unit 512 can select a first image (#1) 600 in time from a plurality of first images (#1, #2, #3, . . . #N) 600 that constitute the dynamic image shown in FIG. 2, as the reference image.

The selection unit 512 may select the reference image according to the degree of blur for each of the plurality of first images. The selection unit 512 may select the first image having the lowest degree of blurring from the plurality of first images as the reference image. When there exists a plurality of first images having the lowest degree of blurring, the selection section 512 may select any one of the plurality of first images as the reference image. The selection unit 512 may select the earliest first image from the plurality of first images as the reference image. The degree of blurring can be determined, for example, by a depth of field. The low degree of blurring refers to, for example, a state where the depth of field is deep. The high degree of blurring refers to, for example, a state where the depth of field is shallow. In addition, the degree of blurring can be determined according to evaluation value of performing contrast autofocus. At this time, the low degree of blurring refers to, for example, a state where the evaluation value is low. The high degree of blurring refers to, for example, a state where the evaluation value is high.

The selection unit 512 may select the reference image according to movement of a captured object within the plurality of first images. For example, the selection unit 512 specifies the captured dynamic object that exists in the plurality of first images, and further specifies a dynamic range of the captured object. The selection unit 512 may select the first image where the captured object exists in the middle position of the dynamic range, as the reference image.

The selection unit 512 may select the reference image according to a difference between each of the plurality of first images. For example, the selection unit 512 may select any one of the plurality of first images as a comparison target image. The selection unit 512 calculates the difference between the comparison target image and the remaining first image, respectively. The difference may be a difference of a predetermined physical quantity derived from each of the plurality of first images. The difference may be a difference in feature amounts derived from each of the plurality of first images. The difference may be a difference in pixel values of the pixels that constitute the image. The difference may be a difference brightness values of the pixels that constitute the image. The difference may be a difference of motion vectors derived from each of the plurality of first images. The selection unit 512 may specify the first image with the largest difference from the comparison target image. The selection unit 512 may use the plurality of first images as the comparison target images, respectively, and specifies the first image having the largest difference from the comparison target image. The selection unit 512 may select the comparison target image having the smallest difference from the other first images, as the reference image.

The alignment unit 513 may align the plurality of first images according to the reference image. The alignment unit 513 may align each of the plurality of first images with the reference image. A position shift may be a deviation of degree of shaking of a hand, that is, a position shift of several pixels in a left-right direction. For example, the alignment unit 513 aligns the first images (#2, #3, . . . #N) 600 shown in FIG. 2, with the plurality of first images (#2′, #3′, . . . #N′) 600 as shown in FIG. 3, based on the first image (#1) 600, as the reference image.

The alignment unit 513 may perform alignment by moving or rotating each of the plurality of first images to minimize the difference from the reference image. The alignment unit 513 may specify at least one common feature point that exists in each of the reference image and the plurality of first images, and move or rotate each of the plurality of first images to perform alignment to make these feature points consistent. By aligning the first image with the reference image, when there is no part corresponding to the reference image at an edge portion of the first image, the alignment unit 513 can keep the edge portion blank. To eliminate the blank portion, the alignment unit 513 may cut the image of the edge portion of the first image by a predetermined number of pixels. The predetermined number of pixels may be a number of pixels corresponding to the deviation of the degree of the shaking of the hand.

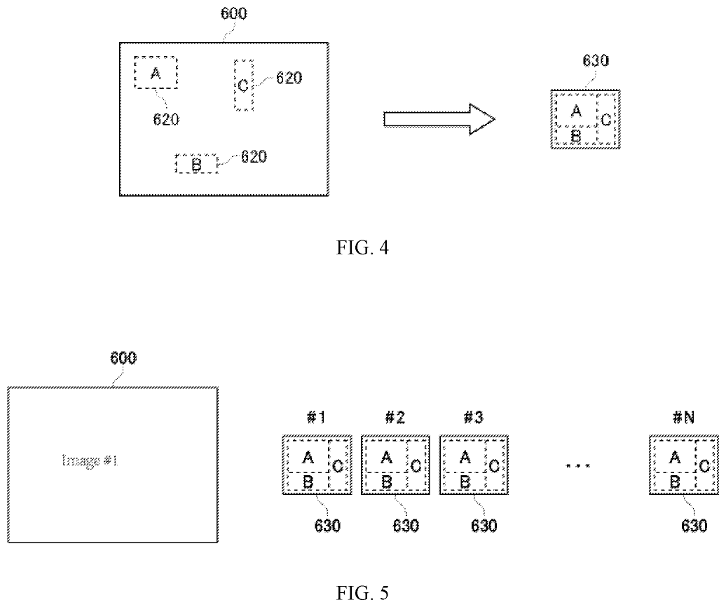

The designation unit 514 may specify at least one partial area in the dynamic image that is composed of the plurality of first images. As shown in FIG. 4, the designation unit 514 may specify a plurality of partial areas 620 within the first image. The designation unit 514 may specify at least one area designated by the user in the first image as at least one partial area. The user can designate a rectangular area as the at least one partial area in such a manner as to surround the captured dynamic object in the dynamic image. The designation unit 514 may detect the dynamic object from the dynamic image, and designate the rectangular area surrounding the dynamic object as the partial area. The designation unit 514 may receive a selection from the user of a desired dynamic object from a plurality of dynamic objects detected in the dynamic image, and designate the rectangular area that surrounds the selected dynamic object as the partial area.

The extraction unit 515 may extract at least one partial image corresponding to the at least one partial area from each of the plurality of first images that constitute the dynamic image, respectively. The generation unit 516 combines the at least one partial image for each of the plurality of first images to generate a plurality of second images whose image sizes are smaller than the first images. For example, as shown in FIG. 4, the generation unit 516 may combine the plurality of partial areas 620 to generate the second image 630.

The generation unit 516 may combine at least one partial image with a predetermined aspect ratio for each of the plurality of first images, and then perform image size reduction at a predetermined resolution, thereby generating the plurality of second images. The generation unit 516 may reduce each of the at least one partial image according to the predetermined aspect ratio and the predetermined resolution for each of the plurality of first images and then combine them, to generate the plurality of second images. The generation unit 516 may adjust the image size reduction rate for each partial image based on the pattern in the partial image. The generation unit 516 may adjust the image size reduction rate for each partial image according to a degree of changes in the brightness of the partial image. The generation unit 516 may reduce the partial images with less brightness changes at an image size reduction rate higher than the partial images with more brightness changes. The generation unit 516 can reduce the partial images by reducing the resolution of the partial images.

The compression unit 517 compresses the plurality of second images according to a predetermined dynamic image compression standard. The predetermined dynamic image compression standard may be a standard of irreversible compression method. The predetermined dynamic image compression standard may be a dynamic image compression standard standardized by ITU-T, such as H.264. The predetermined dynamic image compression standard may be Motion JPEG adopted in digital cameras. The predetermined dynamic image compression standard may be a dynamic image compression standard standardized by MPEG such as MPEG-1, MPEG-2, and MPEG-4.

The generation unit 516 may combine at least one partial image to achieve an aspect ratio and resolution that the compressing unit 517 can compress. The generation unit 516 may combine the at least one partial image according to the aspect ratio and resolution based on the predetermined dynamic image compression standard. The generation unit 516 may combine the at least one partial image according to a predetermined optimization algorithm and the predetermined aspect ratio and resolution. The generation unit 516 may divide, rotate, and reduce, then combine the at least one partial image according to the predetermined aspect ratio and resolution.

The generation unit 516 may generate position information that indicates the position of each partial image in the second image. The position information can be expressed by a coordinate value expressed by a distance (i.e., number of pixels) from a reference point in the second image (e.g., the upper left vertex of the second image) to the horizontal direction and a distance (number of pixels) to the vertical direction. The generation unit 516 may generate reduction rate information that indicates the reduction rate of each partial image of the second image.

As shown in FIG. 5, the compression unit 517 may compress the plurality of second images (#1, #2, #3, . . . #N) according to the predetermined dynamic image compression standard, and store the compressed images in association with the first image (#1) 600 that is used as the reference image in the storage unit 520. The compression unit 517 may store the position information that indicates the position of each partial image in the second image, the reference image, and the plurality of second images in association in the storage unit 520.

When the compression unit 517 reduces each of the at least one partial image according to the predetermined aspect ratio and the predetermined resolution, it can associate the reduction rate for each of the at least one partial image and the reference image, and store the plurality of second images in the storage unit 520.

The communication unit 540 may transmit the plurality of second images (#1, #2, #3, . . . #N) in association with the first image (#1) 600 that is used as the reference image. The communication unit 540 may transmit the plurality of second images (#1, #2, #3, . . . #N) to a predetermined transmission destination in association with the first image (#1) 600 that is used as the reference image. The predetermined transmission destination may be a database as a storage destination for the reference image and the plurality of second images, a display terminal that displays the dynamic picture based on the reference image and the plurality of second images, or the like.

The synthesis unit 518 may synthesize at least two first images from the plurality of first images, and generate a synthesized image with a higher resolution than the first image. The compression unit 517 may store the plurality of second images compressed according to the predetermined dynamic image compression standard in a storage unit in association with the synthesized image. When displaying the image of the dynamic picture, the synthesized image may replace the reference image.

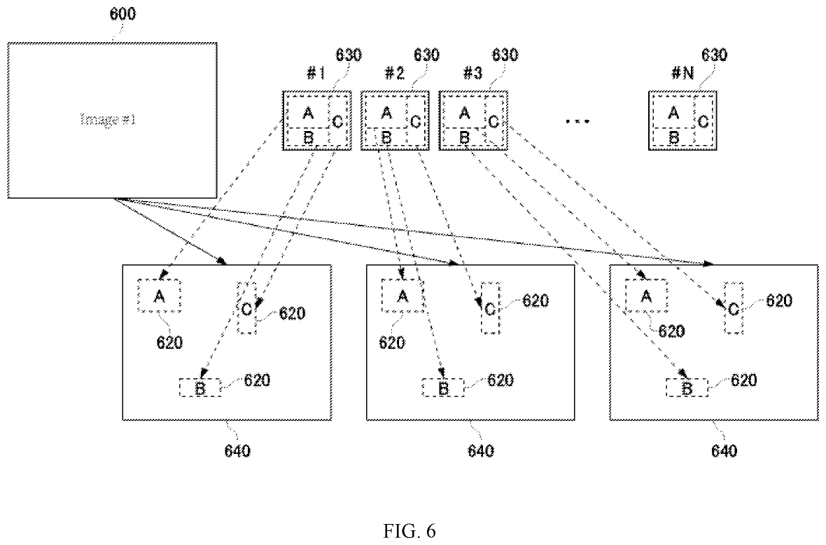

The display control unit 519 displays a video generated by embedding at least one partial image of each of the plurality of second images into the at least one partial area of the reference image, for each of the plurality of second images, on the display unit 530. As shown in FIG. 6, the display control unit 519 may sequentially display the video of the plurality of images 640, which are generated by embedding each partial image that constitutes the second image 630 in each partial area 620 of the first image (#1) 600, as the dynamic picture, on the display unit 530. The display control unit 519 may display, on the display unit 530, the video of the plurality of images that are generated by embedding each partial image that constitutes the second image 630 in an area corresponding to each partial area of the synthesized image generated by the generation unit 518, as the dynamic picture.

As described above, the at least one partial image extracted from each of the plurality of first images that constitutes the dynamic image may be combined to generate the plurality of second images whose image sizes are smaller than the first images. This can effectively reduce the amount of data used for the dynamic images in the dynamic pictures and the like. The plurality of second images may be generated according to the aspect ratio and resolution based on the predetermined dynamic image compression standard. Accordingly, it can be possible to efficiently compress the plurality of second images in accordance with the predetermined dynamic image compression standard.

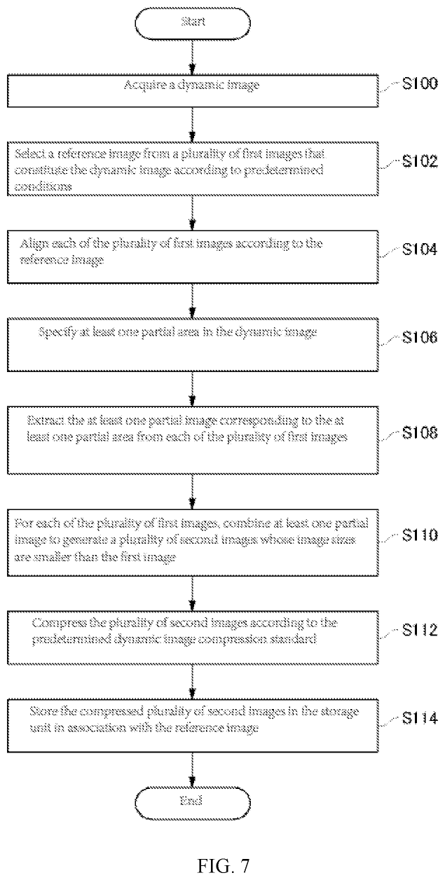

FIG. 7 is a flowchart illustrating processing of the plurality of first images that constitute the dynamic image.

As shown in FIG. 7, in step 100, the acquisition unit 511 acquires a dynamic image. The acquisition unit 511 can acquire the dynamic image that is captured by the camera via the network. The acquisition unit 511 can acquire the dynamic image that is captured by the image capturing apparatus of the image processing apparatus 500.

In step 102, the selection unit 512 selects the reference image from the plurality of first images that constitute the dynamic image according to the predetermined conditions. The selection unit 512 may select the first image in time from the plurality of first images. In step 104, the alignment unit 513 performs alignment for each of the plurality of first images based on the reference image. The alignment unit 513 may align the first images with the reference image by rotating and moving the plurality of first images other than the reference image.

In step 106, the designation unit 514 specifies at least one partial area in the dynamic image. The designation unit 514 may designate at least one area of the dynamic object included in the video of the dynamic picture as the partial area. The designation unit 514 may designate the at least one partial area in the dynamic image according to designation of the user.

In step 108, the extraction unit 515 may extract the at least one partial image corresponding to the at least one partial area from each of the plurality of first images. In step 110, the generation unit 516 combines at least one partial image for each of the plurality of first images to generate a plurality of second images whose image sizes are smaller than the first image. In step 112, the compression unit 517 compresses the plurality of second images according to the predetermined dynamic image compression standard. In step 114, the compression unit 517 stores the compressed plurality of second images in the storage unit 520, in association with the reference image.

As described above, by dynamically compressing and storing the plurality of second images, whose image sizes are smaller than the first images, in the storage unit 520, the amount of data for the dynamic images such as the dynamic pictures can be effectively reduced.

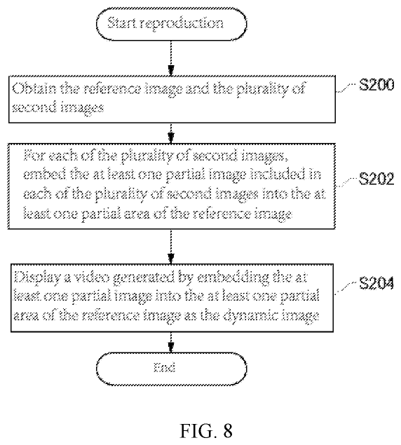

FIG. 8 is a flowchart illustrating a process of reproducing the video of the dynamic picture according to an embodiment of the present disclosure. As shown in FIG. 8, in step 200, the display control unit 519 acquires the reference image and the plurality of second images from the storage unit 520. The display control unit 519 may expand the compressed plurality of second images according to the predetermined dynamic image compression standard. In step 202, the display control unit 519 embeds the at least one partial image included in each of the plurality of second images into the at least one partial area of the reference image for each of the plurality of second images. In step 204, the display control unit 519 displays a video generated by embedding the at least one partial image into the at least one partial area of the reference image, as the dynamic picture, on the display unit 530.

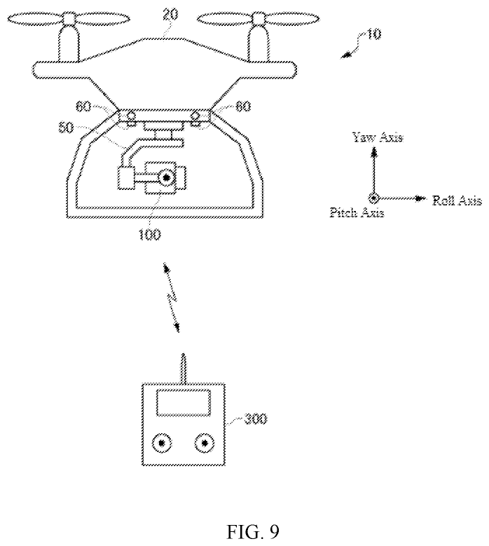

The image processing apparatus 500 as described above may be carried by a mobile body equipped with an image capturing device. The image processing apparatus 500 may be installed in the image capturing device 100 carried by an unmanned aerial vehicle (UAV) as shown in FIG. 9. The UAV 10 may include a UAV body 20, a universal joint 50, a plurality of image capturing apparatuses 60 and an image capturing apparatus 100. The universal joint 50 and the image capturing apparatus 100 are an example of an imaging system. The UAV 10 is an example of a mobile body propelled by a propulsion unit. A mobile body refers to concepts other than UAVs, including flying bodies such as other aircraft movable in the air, vehicles movable on the ground, and vessels movable in the water.

The UAV body 20 includes a plurality of rotors. The plurality of rotors is an example of the propulsion unit. The UAV main body 20 controls the flight of the UAV 10 by controlling the rotation of the plurality of rotors. The UAV body 20 uses, for example, four rotors to make the UAV 10 fly. The number of rotors is not limited to four. In addition, the UAV 10 can also be a fixed-wing aircraft without a rotor.

The image capturing apparatus 100 may be a camera for capturing images of an object included in a desired image capturing range. The universal joint 50 rotatably supports the image capturing apparatus 100. The universal joint 50 is an example of a support mechanism. For example, the gimbal 50 uses an actuator to rotatably support the image capturing device 100 around pitch axis. The universal joint 50 uses an actuator to further rotatably support the image capturing apparatus 100 around roll axis and yaw axis, respectively. The gimbal 50 can change the posture of the image capturing device 100 by rotating the image capturing apparatus 100 around at least one of: the yaw axis, the pitch axis, and the roll axis.

The plurality of image capturing apparatuses 60 are sensing cameras that capture images surrounding the UAV 10 to control the flight of the UAV 10. The two image capturing apparatuses 60 may be installed on a head of the UAV 10, that is, the front. In addition, the other two image capturing apparatuses 60 may be installed on a bottom side of the UAV 10. The two image capturing apparatuses 60 on the front side may be paired to function as a so-called “stereo camera”. The two image capturing apparatuses 60 on the bottom side may also be paired to function as the stereo camera. The three-dimensional space data around the UAV 10 can be generated based on the images captured by the plurality of the image capturing apparatuses 60. The number of the image capturing apparatuses 60 of the UAV 10 is not limited to four. The UAV 10 only needs to include at least one image capturing apparatus 60. The UAV 10 may include at least one image capturing apparatus 60 on the head, tail, side, bottom, and top of the UAV 10, respectively. A viewing angle that can be set in the image capturing apparatus 60 may be larger than a viewing angle that can be set in the image capturing apparatus 100. The image capturing apparatus 60 may have a single focus lens or a fisheye lens.

The remote operation device 300 communicates with the UAV 10 to remotely operate the UAV 10. The remote operation device 300 can perform wireless communication with the UAV 10. The remote operation device 300 transmits to the UAV 10 instruction information indicating various instructions related to the movement of the UAV 10 such as ascent, descent, acceleration, deceleration, forward, backward, and rotation. The instruction information includes, for example, instruction information to increase the height of the UAV 10. The indication information may indicate the height where the UAV 10 should be located. The UAV 10 moves to be at the height indicated by the instruction information that is received from the remote operation device 300. The instruction information may include an ascending instruction to make the UAV 10 ascend. The UAV 10 ascends when receiving the ascending instruction. When the height of UAV 10 reaches an upper limit, the UAV 10 may be restricted from ascending even when receiving the ascending instruction.

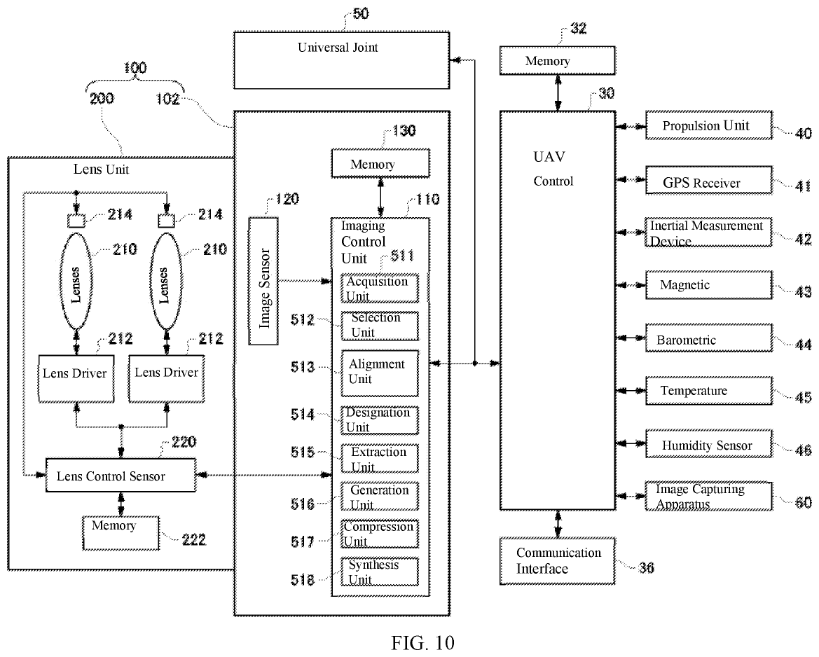

FIG. 10 is an example of the functional blocks of the UAV 10 as shown in FIG. 9. The UAV 10 includes a UAV control unit 30, a memory 32, a communication interface 36, a propulsion unit 40, a GPS receiver 41, an inertial measurement device 42, a magnetic compass 43, a barometric altimeter 44, a temperature sensor 45, a humidity sensor 46, a universal joint 50, an image capturing apparatus 60, and an image capturing apparatus 100.

The communication interface 36 communicates with other devices such as the remote operation device 300. The communication interface 36 can receive instruction information including various instructions for the UAV control unit 30 from the remote operation device 300. The memory 32 stores the program and the like required for the propulsion unit 40, the GPS receiver 41, the inertial measurement device (IMU) 42, the magnetic compass 43, the barometric altimeter 44, the temperature sensor 45, the humidity sensor 46, the universal joint 50, the image capturing apparatus 60, and the image capturing apparatus 100. The memory 32 may be a computer-readable storage medium, and may include at least one of flash memories such as SRAM, DRAM, EPROM, EEPROM, and USB flash drive. The memory 32 may be disposed inside the UAV body 20, and can be set to be detachable from the UAV body 20.

The UAV control unit 30 controls the flight and image capturing of the UAV 10 according to the program stored in the memory 32. The UAV control unit 30 may be composed of a microprocessor such as a CPU or MPU, a microcontroller such as an MCU, or the like. The UAV control unit 30 controls the flight and image capturing of the UAV 10 in accordance with the instructions received from the remote operation device 300 via the communication interface 36. The propulsion unit 40 may propel the UAV 10. The propulsion unit 40 has a plurality of rotors and a plurality of driving motors that can rotate the plurality of rotors. The propulsion unit 40 can rotate the plurality of rotors via the plurality of driving motors according to an instruction from the UAV control unit 30 to make the UAV 10 fly.

The GPS receiver 41 receives multiple signals which indicates the time transmitted from multiple GPS satellites. The GPS receiver 41 calculates a position (i.e., latitude and longitude) of the GPS receiver 41, that is, the position (i.e., latitude and longitude) of the UAV 10 based on the received multiple signals. An IMU 42 detects attitude of the UAV 10. The IMU42 detects acceleration of the UAV 10 in the three axial directions of front-back, left-right, and up-down, and angular velocity in the three axial directions of the pitch axis, the roll axis, and the yaw axis, as the attitude of the UAV10. The magnetic compass 43 detects orientation of the head of the UAV 10. The barometric altimeter 44 detects the flight altitude of the UAV 10. The barometric altimeter 44 detects the air pressure surrounding the UAV 10, and converts the detected air pressure into an altitude to detect the altitude. The temperature sensor 45 detects the temperature surrounding the UAV 10. The humidity sensor 46 detects the humidity surrounding the UAV 10.

The image capturing apparatus 100 includes an image capturing unit 102 and a lens unit 200. The lens unit 200 is an example of a lens device. The image capturing unit 102 includes an image sensor 120, an imaging control unit 110, and a memory 130. The image sensor 120 may be composed of a charge-coupled device (CCD) or a complementary metal-oxide-semiconductor (CMOS). The image sensor 120 captures an optical image formed through a plurality of lenses 210, and outputs the captured image data to the imaging control unit 110. The imaging control unit 110 may be configured by a microprocessor such as a CPU or MPU, a microcontroller such as an MCU, or the like. The imaging control unit 110 may control the image capturing apparatus 100 according to the action instruction of the image capturing device 100 from the UAV control unit 30. The memory 130 may be a computer-readable storage medium, and may include at least one of flash memories such as SRAM, DRAM, EPROM, EEPROM, and USB flash drive. The memory 130 stores the programs required for the imaging control unit 110 to control the image sensor 120 and the like. The memory 130 may be disposed inside casing of the image capturing apparatus 100. The memory 130 may be set to be detachable from the casing of the image capturing apparatus 100.

The lens unit 200 includes a plurality of lenses 210, a plurality of lens driving units 212, and a lens control unit 220. The plurality of lenses 210 can function as zoom lenses, varifocal lenses, and focusing lenses. At least some or all of the plurality of lenses 210 are configured to be movable along the optical axis. The lens unit 200 may be an interchangeable lens that is set to be detachable from the image capturing unit 102. The lens driving unit 212 moves the at least some or all of the plurality of lenses 210 along the optical axis via a mechanism member such as a cam ring. The lens driving unit 212 may include an actuator. The actuator may include a stepping motor. The lens control unit 220 drives the lens driving unit 212 in accordance with the lens control instruction from the image capturing unit 102 to move the plurality of lenses 210 along the optical axis via the mechanism member. The lens control instructions are, for example, zoom control instructions and focus control instructions.

The lens unit 200 also has a memory 222 and a position sensor 214. The lens control unit 220 controls the movement of the lens 210 along the optical axis via the lens driving unit 212 according to the lens action instruction from the image capturing unit 102. Some or all of the plurality of lens 210 move along the optical axis. The lens control unit 220 performs at least one of a zooming operation and a focusing operation by moving at least one of the lenses 210 along the optical axis. The position sensor 214 detects the position of the lens 210. The position sensor 214 may detect a current zoom position or focus position.

The lens driving unit 212 may include a shake correction mechanism. The lens control unit 220 may move the lens 210 along the optical axis or in a direction perpendicular to the optical axis via the shake correction mechanism to perform shake correction. The lens driving section 212 may drive the shake correction mechanism by the stepping motor to perform the shake correction. In addition, the shake correction mechanism may be driven by the stepping motor to move the image sensor 120 along the optical axis or in a direction perpendicular to the optical axis to perform the shake correction.

The memory 222 stores the control values of the plurality of lenses 210 moved via the lens driving unit 212. The memory 222 may include at least one of the flash memories such as SRAM, DRAM, EPROM, EEPROM, and USB flash drive.

In the UAV 10 of this configuration, the image capturing apparatus 100 may have at least a part of the functions of the image processing apparatus 500. More specifically, the imaging control unit 110 may have an acquisition unit 511, a selection unit 512, an alignment unit 513, a designation unit 514, an extraction unit 515, a generation unit 516, a compression unit 517, and a synthesis unit 518 as shown in FIG. 1, to function as the processing unit 510.

The compression unit 517 may compress the plurality of second images generated by the generation unit 516 and store them in the memory 130 or the memory 32 in association with the reference image. The UAV control unit 30 may transmit the reference image and the plurality of second images stored in the memory 130 or the memory 32 to the display terminal such as the remote operation device 300 via the communication interface 36. The display terminal such as the remote operation device 300 functions as the display control unit 519, and can display a video generated by embedding the at least one partial image into the at least one partial area of the reference image on the display unit, as the video of the dynamic picture.

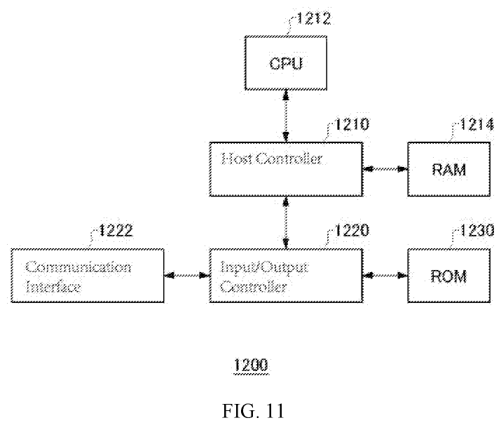

FIG. 11 shows an example of a computer 1200 that can embody various aspects of the present disclosure in whole or in part. The program installed on the computer 1200 enables the computer 1200 to function in the operations associated with the apparatus according to the embodiments of the present disclosure or as one or more “parts” of the apparatus. Alternatively, the program enables the computer 1200 to perform the operations or the one or more “parts”. This program enables the computer 1200 to execute the process according to the embodiments of the present disclosure or the stage of the process. The program may be executed by the CPU 1212 so that the computer 1200 can perform the specific operations associated with some or all of the blocks in the flowcharts and block diagrams described in the disclosure.

The computer 1200 of this embodiment may include a CPU 1212 and a RAM 1214, which are connected to each other through a host controller 1210. The computer 1200 further includes a communication interface 1222 and an input/output unit, which are connected to the host controller 1210 through the input/output controller 1220. The computer 1200 further includes a ROM 1230. The CPU 1212 operates in accordance with the program stored in the ROM 1230 and the RAM 1214 to control each unit.

The communication interface 1222 communicates with other electronic devices through the network. The hard drive can store programs and data used by the CPU 1212 of the computer 1200. The ROM 1230 stores therein a boot program and the like executed by the computer 1200 during operation, and/or a program dependent on the hardware of the computer 1200. The program is provided through a computer-readable storage medium such as a CR-ROM, a USB flash drive, an IC card, or a network. The program is installed in the RAM 1214 or ROM 1230, which is also an example of a computer-readable storage medium, and is executed by the CPU 1212. The information processing described in these programs may be read by the computer 1200 which can further make cooperation between the programs and the various types of hardware resources described above. The apparatus or method may be constituted by implementing operations or processing of the information as using the computer 1200.

For example, when performing communication between the computer 1200 and an external device, the CPU 1212 can execute the communication program loaded in the RAM 1214, and instruct the communication interface 1222 to perform communication processing according to the processing described in the communication program. Under the control of the CPU 1212, the communication interface 1222 reads the transmission data stored in the transmission buffer provided in the storage medium such as RAM 1214 or USB flash drive, and transmits the read transmission data to the network, or write the received data from the network into the reception buffer and the like provided in the storage medium.

In addition, the CPU 1212 enables the RAM 1214 to read all or necessary parts of files or databases stored in an external storage medium such as a USB flash drive, and perform various types of processing of the data on the RAM 1214. Then, the CPU 1212 can write the processed data in the external storage medium.

Various types of information such as various types of programs, data, tables, and databases can be stored in the storage medium and subjected to information processing. For the data read from the RAM 1214, the CPU 1212 can perform various types of operations specified by the sequence of instructions, information processing, condition judgment, conditional transfer, unconditional transfer, and various types of processing such as retrieval/substitution of information that was described in the present disclosure, and write the result in the RAM 1214. In addition, the CPU 1212 can retrieve information in files, databases, and so on, in the storage medium. For example, when a plurality of entries having the attribute values of the first attribute respectively associated with the attribute values of the second attribute are stored in the storage medium, the CPU 1212 may retrieve the entries whose attribute values match the specified first attributes from the plurality of entries, and read the attribute values of the second attribute stored in the entry, to obtain the attribute value of the second attribute associated with the first attribute that meets the predetermined conditions.

The program or software module described above may be stored in the computer 1200 or a computer-readable storage medium near the computer 1200. In addition, the storage medium such as a hard disk or RAM provided in a server system connected to a dedicated communication network or the Internet may be used as the computer-readable storage medium, to provide the program to the computer 1200 via the network.

It should be noted that the order of execution of the actions, sequences, steps, and stages of the devices, systems, programs, and methods shown in the claims, the description, and the drawings in the description, unless otherwise specifically stated “before”, “in advance”, etc., and as long as the output of the previous processing is not used in the subsequent processing, it can be implemented in any order. The operation flow in the claims, the description, and the drawings in the description has been described using “first”, “next”, etc. for convenience, but this does not mean that they must be implemented in this order.

The present disclosure has been described above using embodiments, but the technical scope of the disclosure is not limited to the scope described in the above embodiments. It is apparent to those skilled in the art that variations or improvements can be made to the above-mentioned embodiments. It is apparent from the description of the claims that such variations or improvements shall be included in the technical scope of the disclosure.

What is claimed is:

1. An image processing apparatus, comprising:
a memory storing a program; and
a processor configured to execute the program to:
specify at least one partial area of a dynamic image;
extract at least one partial image corresponding to the at least one partial area from each of a plurality of first images constituting the dynamic image; and
combine the at least one partial image, for each of the plurality of first images, to generate a plurality of second images, the plurality of second images having image sizes smaller than that of the first image.

2. The image processing apparatus according to claim 1, wherein the processor is further configured to execute the program to compress the plurality of second images according to a predetermined dynamic image compression standard.

3. The image processing apparatus according to claim 1, wherein the processor is further configured to execute the program to:
select a reference image from the plurality of first images according to predetermined conditions; and
align the plurality of first images with the reference image and extract at least one partial image corresponding to the at least one partial area from each of the aligned plurality of first images.

4. The image processing apparatus according to claim 3, wherein the processor is further configured to execute the program to:
compress the plurality of second images in accordance with a predetermined dynamic image compression standard and to store the compressed second images in a storage unit in association with the reference image.

5. The image processing apparatus according to claim 3, wherein the processor is further configured to execute the program to:
compress the plurality of second images according to a predetermined dynamic image compression standard; and
transmit the plurality of second images compressed by the compression unit to a transmission destination in associated with the reference image.

6. The image processing apparatus according to claim 3, wherein the processor is configured to execute the program to select the reference image according to a degree of blurring for each of the plurality of first images.

7. The image processing apparatus according to claim 3, wherein the processor is configured to execute the program to select the reference image according to a movement of a captured object within the plurality of first images.

8. The image processing apparatus according to claim 3, wherein the processor is configured to execute the program to select the reference image based on a difference between each of the plurality of first images.

9. The image processing apparatus according to claim 1, wherein the processor is further configured to execute the program to:
synthesize at least two first images of the plurality of first images and generate a synthesized image with a higher resolution than the first image; and
compress the plurality of second images according to a predetermined dynamic image compression standard and to store the compressed second images in a storage unit in association with the synthesized image.

10. The image processing apparatus according to claim 1, wherein, for each of the plurality of first images, the processor is configured to execute the program to combine the at least one partial image with a predetermined aspect ratio and perform image size reduction at a predetermined resolution to generate the plurality of second images.

11. The image processing apparatus according to claim 1, wherein the processor is configured to execute the program to perform image size reduction to each of the at least one partial image, for each of the plurality of first images, according to a predetermined aspect ratio and a predetermined resolution, and combine the reduced images to generate the plurality of second images.

12. The image processing apparatus according to claim 3, wherein the processor is configured to execute the program to:
perform image size reduction to each of the at least one partial image, for each of the plurality of first images, according to a predetermined aspect ratio and a predetermined resolution, and combine the reduced images to generate the plurality of second images; and
compress the plurality of second images according to the predetermined dynamic image compression standard and store a reduction ratio of each of the at least one partial image in a storage unit associated with the reference image.

13. The image processing apparatus according to claim 3, wherein the processor is further configured to execute the program to:
display a video generated by embedding at least one partial image included in each of the plurality of second images into at least one partial area of the reference image, for each of the plurality of second images.

14. The image processing apparatus according to claim 1, wherein the processor is further configured to execute the program to:
synthesize at least two first images of the plurality of first images to generate a synthesized image with a higher resolution than that of the first image; and
display a video generated by embedding at least one partial image included in each of the plurality of second images into an area corresponding to at least one partial area of the synthesized image, for each of the plurality of second images.

15. The image processing apparatus according to claim 3, wherein the processor is configured to execute the program to keep an edge portion of the plurality of first images blank in response to no part corresponding to the reference image at the portion of the plurality of first images.

16. The image processing apparatus according to claim 15, wherein the processor is further configured to cut the edge portion of the plurality of first images based on a predetermined number of pixels to eliminate the blank.

17. The image processing apparatus according to claim 3, wherein the processor is configured to execute the program to align the plurality of first images by moving or rotating each of the plurality of first images.

18. The image processing apparatus according to claim 1, wherein the one partial area is associated with a rectangular area that surrounds an object in the dynamic image.

19. An image capturing apparatus for capturing dynamic image, comprising: an image processing apparatus, wherein the image processing apparatus comprises:
a memory storing a program; and
a processor configured to execute the program to:
specify at least one partial area of a dynamic image;
extract at least one partial image corresponding to the at least one partial area from each of a plurality of first images constituting the dynamic image; and
combine the at least one partial image, for each of the plurality of first images, to generate a plurality of second images, the plurality of second images having image sizes smaller than that of the first image.

20. A mobile body having an image capturing apparatus, comprising:
an image processing apparatus, comprising:
a memory storing a program; and
a processor configured to execute the program to:
specify at least one partial area of a dynamic image;
extract at least one partial image corresponding to the at least one partial area from each of a plurality of first images constituting the dynamic image; and
combine the at least one partial image, for each of the plurality of first images, to generate a plurality of second images, the plurality of second images having image sizes smaller than that of the first image.
